(19) United States
(12) Patent Application Publication
(10) Pub. No.: US 2005/0138606 A1
(43) Pub. Date: Jun. 23, 2005

(54) System and method for code migration

(76) Inventors: Sujit Basu, Alpharetta, GA (US); Khalid Beg, Santa Clara, CA (US); Bruno Chartier, Santa Clara, CA (US); Ted Chau, Anaheim, CA (US); Cheok Han Chu, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/738,318

(22) Filed: Dec. 17, 2003

(51) Int. Cl. G06F 9/45; G06F 9/44; G06F 15/00

(52) U.S. Cl. 717/136; 717/114; 715/513

(57) ABSTRACT

One disclosed method for converting data suitable for use on a source platform into data suitable for use on a target platform comprises analyzing source platform code; extracting information from the analyzed source platform code wherein the extracted information includes at least the logic, flow, user interface description, and data of the source platform code; defining a generic data structure and format for storing the extracted information; storing the extracted information in the defined structure and format; and transforming the extracted information into code suitable for the target platform wherein the transforming step comprises transforming the extracted information into code suitable for the target platform after the extracted information is stored in the defined structure and format.

### FIELD OF THE INVENTION

This invention relates in general to code translation, and more specific, to transforming code from one language to another language.

### DESCRIPTION OF THE RELATED ART

Information Technology (IT) systems play a large part in the routine activities of a majority of today's business operations. When an IT system is phased out, businesses usually upgrade to a newer version or change to a different system altogether. When upgrading to a newer version, the process is usually fast with little to no downtime.

Businesses may also decide to change an existing IT system to a different system altogether due to mergers, spin-offs, or other business decisions. When installing a new IT system, users often desire to have applications from the previous IT system available in the new IT system. In order to implement applications from one IT system or platform to a new IT system or platform, the desired applications of the older system are often converted/implemented into the new IT system.

Typically, conversions from an existing IT system to a new IT system are manually done in order to implement the desired applications from the old IT system into the new IT system. Conversion from an old IT system to a new IT system may save money by re-using the functionality of old assets with the new system. However, any money saved by re-using the functionality of old assets will usually be outweighed by the expenses associated with the manual conversion and downtime during the time of change from the old IT system to the new IT system. In addition, the conversion process from the old IT system to the new IT system typically requires an extensive knowledge of the differences between the old IT system and the new IT system, and is usually more expensive than a simple upgrade to a newer version of an existing IT system. Along with the vast knowledge of both the new and old IT systems, a considerable amount of time is required to resolve the incompatibilities between the old and new IT systems while implementing the desired applications from the old IT system into the new IT system. With all the time and expenses associated with the change from an old IT system to a new IT system, businesses will typically decide to upgrade to a newer version of the old system and loose all the advantages associated with a new IT system.

### BRIEF SUMMARY OF THE INVENTION

One embodiment provides a method for converting data suitable for use on a source platform into data suitable for use on a target platform. The method comprises analyzing source platform code; extracting information from the analyzed source platform code wherein the extracted information includes at least the logic, flow, user interface description, and data of the source platform code; defining a generic data structure and format for storing the extracted information; storing the extracted information in the defined structure and format; and transforming the extracted information into code suitable for the target platform wherein the transforming step comprises transforming the extracted information into code suitable for the target platform after the extracted information is stored in the defined structure and format.

Another embodiment provides a data processing system for transforming a computer program written for a source platform to a computer program written for a target platform. The data processing system comprises memory storing a transformation program operating to analyze a program operating on a source platform; to extract information from the analyzed source platform code, wherein the extracted information includes at least the logic, flow, user interface, and data of the source platform code; to define a generic data structure and format; to store the extracted information in the defined generic data structure and format; and to transform the extracted information stored in the defined generic data structure and format into code suitable for the target platform; and a processor for executing the transformation program.

### BRIEF DESCRIPTION OF THE DRAWINGS

FIG. 1 is a diagram illustrating a general architecture of a method for the migration of computer language from one language to another language, according to an embodiment of the present invention;

FIG. 2 is a diagram illustrating the components of a software architecture for translating computer code, according to an embodiment of the present invention;

FIG. 3 is a diagram illustrating a detailed overview of a utilization process for migrating computer code, according to an embodiment of the present invention; and

FIG. 4 depicts a block diagram of a computer system which is adapted to use an embodiment of the present invention.

### DETAILED DESCRIPTION

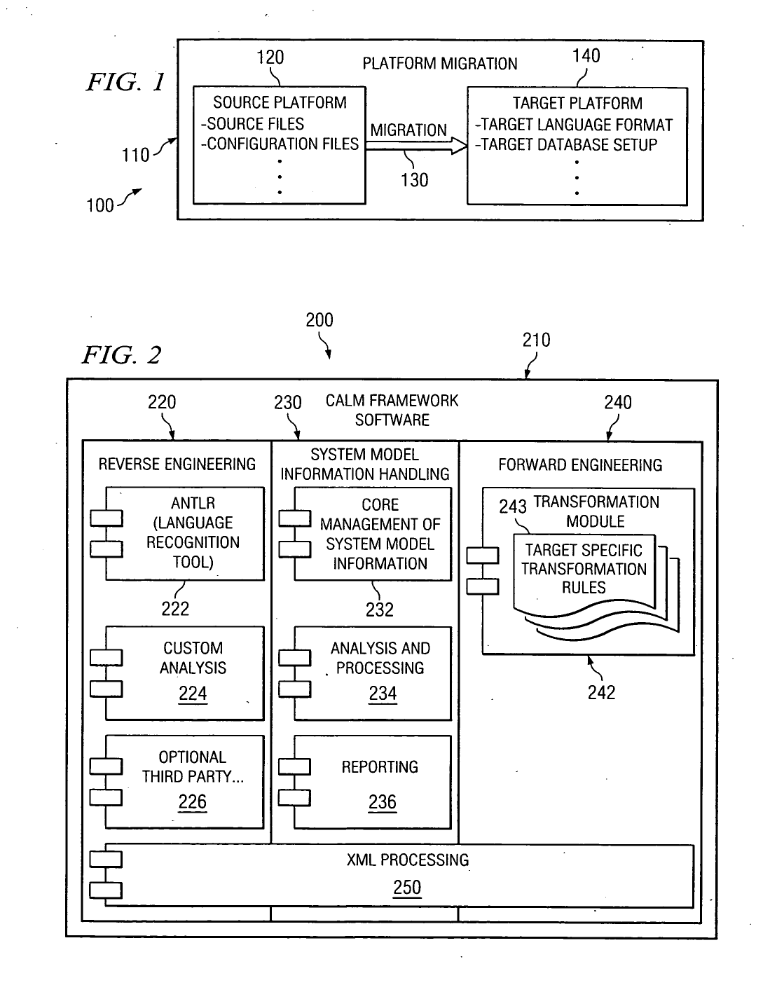

FIG. 1 is a diagram illustrating a general architecture 100 for migrating computer language from one language to another language. In one embodiment, general architecture 100 includes a platform migration 110. As illustrated in FIG. 1, platform migration 110 includes migration 130 of computer language from source platform 120 to target platform 140. In general, the available data of source platform 120 will be analyzed and stored in a generic reusable format during migration 130. The generic reusable format is a set of information elements that reflect the relevant aspects of the computer code originating at the source platform that is to be transformed into a format suitable for the target platform. The generic reusable format will then be made available for further analysis and reporting, and will eventually be transformed into an appropriate format suitable for use by target platform 140 during migration 130. The generic reusable format is also known as the system model information.

Source platform 120 and target platform 140 may be an underlying computer system on which application programs can run. The underlying computer system may include an operating system, a computer's coordinating program that is built on the instruction set for a processor or a microprocessor, and the hardware that performs the logic operations and manages the data movement of the computer. For example, on a personal computer, WINDOWS® XP, MACINTOSH® Mac OS X, Java J2EE, MS.NET, as well as 4GL environments, such as Mapper from Unisys and Oracle PL/SQL are examples of different platforms.

In one embodiment, source platform 120 represents the platform that is the starting point for translation/migration to another platform, such as target platform 140. Target platform 140 represents the platform to which the various files of the source platform 120 are migrated/translated to, so that target platform 140 is able to use the translated files. Target platform 140 may have a target language format which indicates the format in which files from source platform 120 need to be converted into in order for target platform 140 to use the files from source platform 120. For example, source platform 120 may operate with COBOL language files, while target platform 140 operates with JAVA language files. Migration 130 operates to transform the COBOL language files on source platform 120 into JAVA language files. Thus, the COBOL files on source platform 120 can operate on target platform 140 as JAVA files, after the process of migration/translation is performed by migration 130. Target platform 140 may also include a target database setup which will indicate the database format used by target platform 140. For example, migration 130 may be used to transform a database in Unisys Mapper format to a corresponding database in an Oracle format. In alternative embodiments, migration may be applied to any number of various types of computer language files that may operate on source platform 120 in order to convert the various files into the format required by target platform 140.

Migration 130 is the act or process of translation or migration from a first language to a second language. During translation/migration from a first language on source platform 120 to a second language required by target platform 140, platform migration 110 operates to extract the logic, flow, user interface (screens) definitions, and data from the application (s) in the first language on source platform 120. After extracting the logic, flow, user interface (screens) definitions, and data, migration 130 will transform this logic, flow, user interface (screens) definitions, and data into logic, flow, user interface (screens) definitions, and data of a corresponding application in a second language that is formatted to operate on target platform 140.

The logic extracted by platform migration 110 is extracted from the application(s) in the first language on source platform 120 and represents the actual operations of the application(s) in the first language on source platform 120. The extracted logic represents various operations, such as sorting, comparing, matching, and may involve yes-no decisions. For example, in a program that computes the grade point averages of students and then ranks the students corresponding to the computed grade point average, platform migration 110 will extract the logic associated with the computing and ranking, and then translate that logic into a logic suitable for use in a second language on target platform 140, so that target platform 140 can run the same operations of the logic executed on source platform 120.

The flow extracted from the application(s) in the first language represents the sequence in which various operations are performed in the application(s) in the first language on source platform 120. For example, in a program that comprises several screens that are presented to a user in a certain sequence, such as a log-in screen that is presented first, followed by a data entry screen, followed by a screen to confirm the data entry, etcetera, the sequence in which the screens are presented to a user will be extracted by platform migration 110. After the flow is extracted, the flow will be translated into an appropriate language for target platform 140 so that the same flow, such as the sequence of windows, will be presented to a user operating the translated program on target platform 140.

The user interfaces of source platform 120 will also be extracted and translated during migration 130 so that the user interfaces of source platform 120 will be present in target platform 140. User interfaces/screens are what users of a system view during the execution of the application, and are typically defined in the system by describing the screen elements and their positioning on the screen. For example, a user interface screen may comprise graphical elements like pictures and diagrams, a text input field, buttons, labels, hot links, etcetera.

Platform migration 110 also extracts and translates the data of a first program on source platform 120 when migrating code from source platform 120 to target platform 140. For example, in a program that contains several entries, such as a database of students registered for a particular class, migration 130 will extract and translate the data entries into the appropriate form required by target platform 140, so that a user of target platform 140 can access the same data, such as the entries of students registered for a particular class, that was available on source platform 120.

FIG. 2 is a diagram illustrating the components of a software architecture 200 for translating computer code. In one embodiment, software framework 210 includes reverse engineering component 220, system model information handling component 230, and forward engineering component 240.

Framework 210 operates to create and manage system model information. The system model information is a generic reusable format representing a set of information elements that reflect the relevant aspects of the computer code originating at the source platform, such as the flow, logic, user interface, data, etcetera. As illustrated by eXtensible Markup Language (XML) Processing block 250, these elements may be stored in an XML format. By using XML, the system model information is stored in an XML format which results in the system model information having a persistent configuration so that the system model information may be easily stored, modified, and exchanged with other applications. The XML format also allows for the future use of any extracted information. However, framework 210 is not restricted to the use of XML as other formats may be implemented in other embodiments.

Reverse engineering component 220 represents the source of data extraction in framework 210. Reverse engineering component 220 operates to provide the data source for system model information handling component 230. Relevant information, such as the pertinent aspects of the computer code operating on the source platform, is extracted from the source platform data by reverse engineering component 220. This relevant system model information is stored in an intermediate format, such as XML data, and inputted to the system model information handling component 230 for further processing, analysis, and/or reporting.

In one embodiment, as illustrated in FIG. 2, reverse engineering component 220 may include various modules to assist with the reverse engineering of the source platform computer code. For example, reverse engineering component 220 may include specific extended Backus-Naur form (EBNF) grammar language recognition libraries, such as the ANTLR language recognition tool 222, to recognize elements of a particular program written in a particular language. Language specific EBNF grammars operate to recognize a set of lexic characters coming from a source code. The actions within the EBNF grammar will facilitate how the extraction of relevant elements from the source platform computer code will be executed. However, framework 210 is not restricted to the use of EBNF grammar language recognition libraries or the ANTLR language recognition tool 222, as any number of various language recognition tools may be used with framework 210.

In one embodiment, reverse engineering component 220 may also include a custom analysis tool 224 and/or optional third party tools 226. Custom analysis tool 224 and optional third party tools 226 may be used so that the source platform computer code can be properly processed by ANTLR language recognition tool 222. Custom analysis tool 224 may be used either before or after the use of ANTLR language recognition tool 222. Custom analysis tool 224 facilitates the extraction process through the pre-processing or post-processing of the source platform computer code. The pre-processing and post-processing is specific to a particular language of the source platform computer code and works as a pluggable tool for framework 210. As transformation moves on, a repository of pluggable tools is created which can be used for a particular transformation task.

Optional third party tools 226 may be used in reverse engineering component 220 to assist with the extraction of the system model information and analysis of the source platform computer code. For example, regular expressions or regular expression libraries may be used to do some pre-processing or post-processing of language files, such as source code files, language documentation, etcetera. When framework 210 acquires a representative set in the source platform source code, third party tools 226 can help to analyze the source code to identify certain elements that need to be inserted or removed in the language files, such as certain comment lines, characters, etcetera. In one embodiment, third party tools 226 may include items, such as a COBOL language library, a C or C++ language library, a JAVA language library, etcetera, which will ease the information extraction.

System model information handling component 230 processes the set of information elements that reflect the relevant aspects of the computer code originating at the source platform (system model information) extracted by reverse engineering component 220. System model information handling component 230 operates around the creation of the intermediate XML data representing the system model information extracted from reverse engineering component 220. In one embodiment, system model information handling component 230 may include core management of system model information module 232, analysis and processing module 234, and reporting module 236. System model information handling components may also include eXtensible Stylesheet Language (XSLT) based reporting capabilities.

Core management of system model information module 232 operates to define the intermediate XML format in which the extracted information/system model information is stored. The stored XML format includes two entities, the results of the extraction from reverse engineering component 220 (the data) and the definition of how this data is forwarded in XML (data definition). The core management of system model information module 232 will create the specific XML information, based on the data definition.

In one embodiment, analysis and processing module 234 may be used prior to reporting to do some intermediate transformation of the system model information. The extracted system model information may also be analyzed and processed further by analysis and processing module 234 to obtain additional relevant information that is detected with various grammar libraries.

Reporting module 236 operates to generate reports from the XML data representing the system model information. Reporting module 236 may obtain useful information from the XML system model information and use this information to generate various reports about the system model information. For example, the generated reports may include user interface mock-ups, database table definitions, symbol counts, generic XML reports, human readable reports, etcetera.

Forward engineering component 240 will take the intermediate XML data representing the system model information that was extracted from the source platform computer code by reverse engineering 220 and transform the intermediate XML data into the target platform computer code useable by the target platform. Forward engineering component 240 is developed to accommodate system model information and target platform specificities. As illustrated in FIG. 2, forward engineering component 240 includes transformation module 242. Transformation module 242 transforms the intermediate XML data of the system model information into the data required by the target platform. In one embodiment, transformation module 242 may include a set of target specific transformation rules 243 to insure that the intermediate XML data of the system model information is transformed into the correct format required by the target platform.

For example, forward engineering component 240 can take data extracted from the source platform and transform it into program code of specific languages, configuration files, database schemas, user interface definition files, etcetera for use on a target platform.

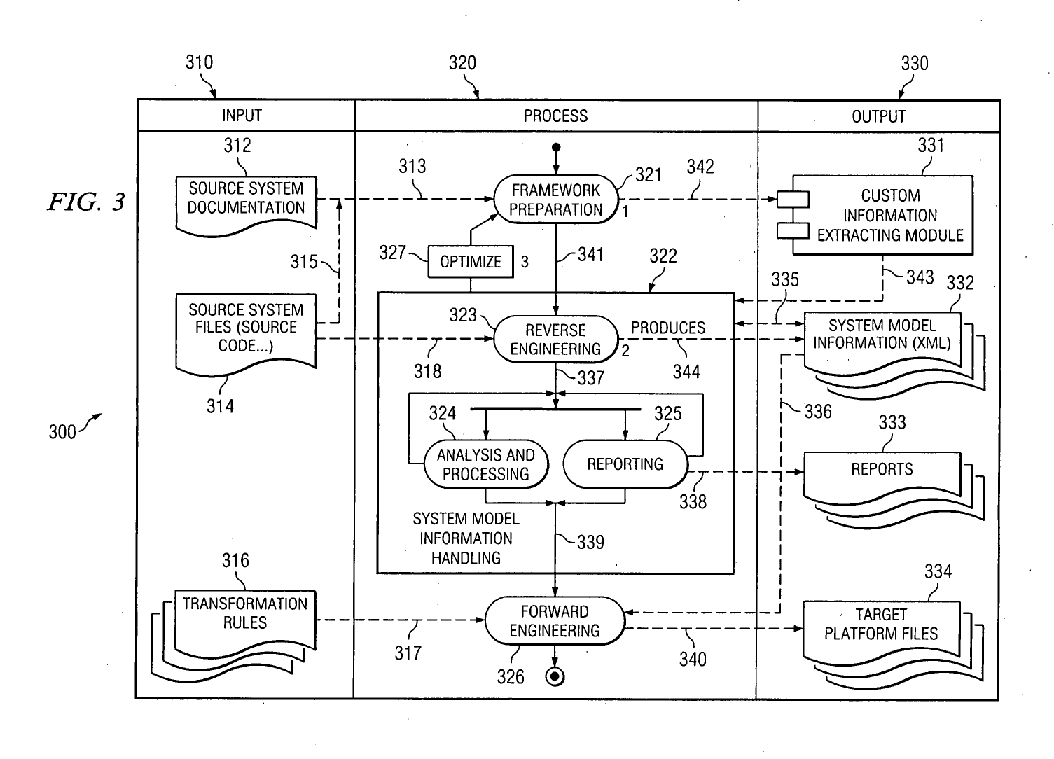

FIG. 3 is a diagram illustrating a detailed overview of a utilization process for migrating computer code from one platform to another platform. Process 300 for migrating computer code includes input block 310, process block 320, and output block 330. Input block 310 illustrates the various inputs to process block 320. Process block 320 illustrates the various operations performed in converting code suitable for one platform into code suitable for another platform. Output block 330 illustrates the various outputs of process block 320.

In one embodiment, input block 310 may include a plurality of inputs, such as source system documentation 312, source system files 314, and transformation rules 316. However, the inputs of process 300 are not restricted to inputs 312, 314, and 316, and in alternative embodiments, process 300 may include any number of various inputs that may assist in the migration of computer code from a source platform to a target platform. Source system documentation 312 includes various documentation and information about the source platform code. Source system files 314 include the actual code from the source platform. Transformation rules 316 include any specific rules that may be needed in generating target platform data from the system model information.

Process block 320 includes framework preparation 321, system model information handling 322, and forward engineering 326. System model information handling 322 may include reverse engineering block 323, analysis and processing block 324, and reporting block 325. Output block 330 illustrates the various outputs generated from process block 320. In one embodiment, output block 330 may include custom information extracting module 331, system model information 332, reports 333, and target platform files 334. However, process 300 is not restricted to these outputs, and process 300 may include any number of various outputs related to the source or target platform code.

Process block 320 begins with framework preparation 321. In one embodiment, there are two inputs to framework preparation 321 illustrated as source system documentation 312 and source system files 314. Source system documentation 312 is input to framework preparation 321 through flow path 313, and source platform code/system files 314 are input to framework preparation 321 through flow path 315. However, in alternative embodiments, process 300 may be configured so that there are more or less than two inputs to framework preparation 321. In addition, inputs to framework preparation 321 are not restricted to inputs 312 and 314 as process 300 may be configured so that any number of various inputs may be inputted to framework preparation 321.

Framework preparation 321 operates to provide and customize the necessary tools related to information extraction, so that this step may not be done during the actual extraction of information. Framework preparation 321 also prepares the source platform code for reverse engineering 323. Specifically, during framework preparation 321, some analysis and removal of irrelevant elements from the source platform code may be conducted in order to prepare the source platform code for reverse engineering 323. After the source platform code has been prepared for reverse engineering 323, the prepared source platform code is outputted to reverse engineering 323 of system model information handling 322, as illustrated by flow path 341. The analysis of the source platform code is specific to the source platform code and to the status of the source platform code. For example, non-standard information that is not relevant for the code transformation may be removed during framework preparation 321. Information removed during framework preparation 321 can be stored in XML format for later use. In alternative embodiments, process 300 may be configured so that there is no framework preparation 321 or so that process 320 bypasses framework preparation 321. In such an embodiment, the source platform code/system files 314 will be inputted directly to reverse engineering 323 as illustrated by flow path 318.

In one embodiment, process 300 may be configured so that framework preparation 321 also outputs data to custom information extracting module 331 as illustrated by flow path 342. Custom information extracting module 331 may include a custom set of instructions that will help to interpret or extract relevant and useful data from the source platform code. For example, the source platform code may include code that is specific to a particular operating system in which there may be no existing language libraries available to help extract the relevant data from the source platform code. In this case, the custom information extracting module 331 may include a specialized language library developed specifically for assisting with the extraction and reverse engineering of the platform source code. Specifically, the source platform code will be sent to framework preparation 321, and then sent to custom information extracting module 331, which will assist in preparing the specific source platform code for reverse engineering 323. After the specific source platform code is analyzed and prepared for reverse engineering by custom information extraction module 331, the analyzed source platform code will be sent to system model information handling 322 where the code will be further processed by reverse engineering 323, as illustrated by flow 343.

System model information handling 322 manages the system model information. As illustrated in FIG. 3, system model information handling 322 may include reverse engineering block 323, analysis and processing block 324, and reporting block 325. Reverse engineering 323 will take the source platform code from framework preparation 321 and/or from source system files 314, as well as the information from custom information extracting module 331, and produce the system model information 332, as illustrated by flow path 344. Process 300 is arranged so that reverse engineering 323 will produce the system model information 332 in an XML format. However, process 300 may be arranged so that system model information 332 may be implemented in various other formats which can assist in the transformation process of forward engineering 326.

Processing and handling of the source platform code is not restricted to one pass through framework preparation 321 and reverse engineering 323. In alternative embodiments, components of process 300 may be optimized so that the processing of the source platform code is enhanced. Due to complexity constraints and incompatibility problems that may be associated with the source platform, it may be difficult to achieve one hundred percent information extraction and one hundred percent capture of the specific features of the source platform code. Thus, process 300 may be arranged for optimization 327 of various components of process 300. Optimization process 327 indicates the presence of an optimization operation in process 300. Various components, processes, inputs, or flows may be modified by optimization process 327 to optimize process 300. For example, reverse engineering 323 may be optimized by modifying any existing system information extraction libraries and/or creating/acquiring additional information extraction libraries that will assist with the reverse engineering process. Optimization of the system model information handling 322 may occur with changes/additions to the XML data definition representing the system model information. Transformation rules 316 may also be modified in order to produce an improved target platform code generation. Reporting 325 may also be optimized to provide better, clearer, and/or more useful reporting. After optimization of reverse engineering 323, system model information handling 322, transformation rules 316, and reporting 325, the source platform code may be cycled back through framework preparation 321, reverse engineering 323, analysis and processing 324, and reporting 325 in order to create a system model information 332 with an increased accuracy with respect to capturing all relevant aspects and removing all non-relevant aspects of the source platform code. Optimization 327 also helps to produce improved reports 333 and target platform files 334. The optimization may occur multiple times. Yet, in order to keep the consistency of the original application, the source platform code is never modified.

After system model information 332 is produced, it is available for use by analysis and processing 324 and reporting 325 of system model information handling 322, as illustrated by flow paths 335 and 337. Flow path 336 illustrates that system model information 332 may also be directly available to forward engineering 326 regardless if system model information handling 322 includes or does not include analysis and processing 324 and reporting 325. In an alternative embodiment, process 300 may be configured so that system model information handling 322 includes either analysis and processing 324 or reporting 325 or does not include analysis and processing 324 and reporting 325.

Analysis and processing 324 may perform some custom analysis of the system model information 332 before forward engineering 326. For example, analysis and processing 324 may further refine system model information 332 to obtain more relevant information that may be detected with various grammar libraries. The further processing helps to increase the overall effectiveness of the system model information 322 before forward engineering 326. Analysis and processing 324 may also be used to do some intermediate transformation of the system model information to assist with the generation of reports by reporting 325.

In one embodiment, process 300 may be configured so that reporting 325 generates various reports 333 about system model information 332, as illustrated by flow path 338. Reporting 325 may obtain useful information from the XML form of the system model information 332 and use this information to generate various reports 333 for various uses. For example, the generated reports 333 may include user interface mock-ups, database table definitions, symbol counts, generic XML reports to assist in validating or verifying other complex manual migration, reports detailing the status of the migration for platform migration engineers, etcetera. Reports 333 may also be generated in various formats depending on user needs. For example, reports 333 may be generated in HTML, ADOBE® ACROBAT®, MICROSOFT® Word, COREL® WORDPERFECT®, etcetera.

After generation of the system model information 332 or after analysis and processing 324 and reporting 325, the system model information 332 is inputted to forward engineering 326, as illustrated by flow paths 336 and 339, respectively. Forward engineering process 326 may be performed in multiple steps and by using different processing tools and libraries in order to achieve optimal target platform code generation. For example, depending on the target platform environment, complexity and availability of tools, it is typically easier to perform forward engineering by (a) generating standard Structured Query Language (SQL) database populating scripts through an eXtensible Stylesheet Language (XSL) based transformation of the system model database definition, (b) then input these scripts to some third party data modeling tool, and then (c) generate the target Relational Database Management System (RDBMS) proprietary files directly using XSL transformations which requires knowledge of the proprietary file format. While performing these steps, a repository of optimized transformation rules may be created, which is intended to help cover more and more forward engineering areas and target platforms and improve productivity of the framework over time.

Forward engineering 326 operates to transform the system model information 332 into the target platform code/files 334 useable by the target platform, as illustrated by flow path 340. Forward engineering process 326 is based on input data, such as the system model information 332 as well as the XML data definition, transformation rules 316 of the input data, and the generation of the target platform code/files 334. Transformation rules 316, that are specific to the target platform, for transforming the system model information 332 into the target platform files 334 are inputted to forward engineering process 326 to help with the transformation, as illustrated by flow path 317. During forward engineering 326, the system model information 332, which is stored in XML format, is taken as an input to forward engineering 326 and any special transformation rules 316 are also taken as an input, and the output of forward engineering 326 is the target platform code, as illustrated by target platform files 334 and flow path 340.

The generation of the target platform code 334 by the forward engineering process 326 may be accomplished with the tools and libraries applying the transformation rules 316 as well as applying any subsequent post processing steps on the generated target code 334. In an alternative embodiment, the transformation rules 316 of the input data are implemented using eXtensible Stylesheet Language Transformations (XLST). The XLST transformation rules may be composed of XSL transformation files containing directives to transform elements of the system model information into elements of the target code. For example the directive may be a directive to transform the logic captured in the system model information into the same logic using the target platform programming language syntax; a directive to transform source platform database table definitions into target platform database definitions; a directive to create scripts to allow automated data migration, such as scripts allowing the reading of the source platform data records and saving them into the target platform database system; a directive to create target platform user interface screen definitions, such as transforming a “green screen” type of user interface of the source platform into a HTML based user interface which can be done by capturing the position of text and input fields on the source platform screen, and then transforming this information into HTML code; etcetera.

When implemented in software, the elements of the embodiments are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etcetera. The computer data signal may include any signal that can propagate over a transmission medium such as electronic network channels, optical fibers, air, electromagnetic, RF links, etcetera. The code segments may be downloaded via computer networks such as the Internet, Intranet, etcetera.

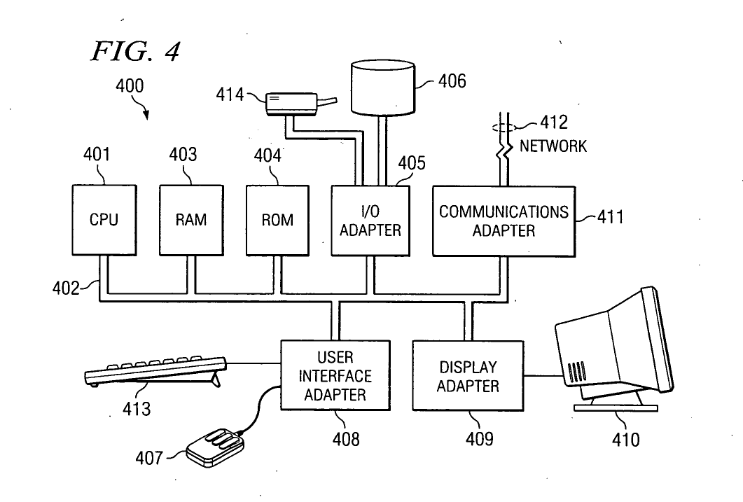

FIG. 4 illustrates computer system 400 adapted to use embodiments of the present invention, e.g. storing and/or executing software associated with the embodiments. Central processing unit (CPU) 401 is coupled to system bus 402. The CPU 401 may be any general purpose CPU, such as an HP PA-8500 or Intel Pentium processor. However, embodiments of the present invention are not restricted by the architecture of CPU 401 as long as CPU 401 supports the inventive operations as described herein. Bus 402 is coupled to random access memory (RAM) 403, which may be SRAM, DRAM, or SDRAM. ROM 404 is also coupled to bus 402, which may be PROM, EPROM, or EEPROM. RAM 403 and ROM 404 hold user and system data and programs as is well known in the art.

Bus 402 is also coupled to input/output (I/O) controller card 405, communications adapter card 411, user interface card 408, and display card 409. The I/O adapter card 405 connects storage devices 406, such as one or more of a hard drive, a CD drive, a floppy disk drive, a tape drive, to computer system 400. The I/O adapter 405 is also connected to printer 414, which would allow the system to print paper copies of information such as documents, photographs, articles, etcetera. Note that the printer may be a printer (e.g. dot matrix, laser, etcetera.), a fax machine, scanner, or a copier machine. Communications card 411 is adapted to couple the computer system 400 to a network 412, which may be one or more of a telephone network, a local (LAN) and/or a wide-area (WAN) network, an Ethernet network, and/or the Internet network. User interface card 408 couples user input devices, such as keyboard 413, pointing device 407, etcetera to the computer system 400. The display card 409 is driven by CPU 401 to control the display on display device 410.

1. A method for converting data suitable for use on a source platform into data suitable for use on a target platform, said method comprising:
analyzing source platform code;
extracting information from said analyzed source platform code wherein said extracted information includes at least the logic, flow, user interface description, and data of said source platform code;
defining a generic data structure and format for storing said extracted information;
storing said extracted information in said defined structure and format; and
transforming said extracted information into code suitable for said target platform wherein said transforming step comprises transforming said extracted information into code suitable for said target platform after said extracted information is stored in said defined structure and format.

2. The method of claim 1 wherein said defined structure and format is XML.

3. The method of claim 1 wherein said analyzing of said source platform code comprises:
defining a language recognition tool; and
using said defined language recognition tool to recognize elements of a program in a particular language.

4. The method of claim 3 wherein said language recognition tool is based on an EBNF programming language grammar.

5. The method of claim 3 wherein said language recognition tool is an ANTLR language recognition tool.

6. The method of claim 5 wherein said analyzing step further comprises:
defining a custom analysis tool that is specific to said source platform code; and
using said defined custom analysis tool to pre-process said source platform code before said extracting of information.

7. The method of claim 5 wherein said analyzing step further comprises:
defining a custom analysis tool that is specific to said source platform code; and
using said defined custom analysis tool to post-process said source platform code after said extracting of information

8. The method of claim 6 wherein said analyzing step further comprises:
defining a third party tool to be used for analyzing said source platform code; and
using said defined third party tool to identify elements of said source platform code that are relevant and not-relevant to said transforming of said extracted information.

9. The method of claim 1 further comprising:
producing a report from said extracted information.

10. The method of claim 9 further comprising:
analyzing and performing an intermediate transformation of said extracted information to assist with said report producing step.

11. The method of claim 9 wherein said report comprises at least one of:
a user interface mock-up;
data definitions;
symbol counts;
application flow;
a generic XML report to assist in validating or verifying other complex manual migration of code from one platform to another platform; and
details of a status of migration of code from one platform to another platform for a user.

12. The method of claim 1 wherein said transforming step comprises:
defining a set of transformation rules specific to said target platform; and
using said transformation rules in transforming said extracted information into code suitable for said target platform.

13. A mechanism for migrating computer code from a source platform to a target platform comprising
a means for preparing source files;
a means for reverse engineering said prepared source files into an intermediate code;
a means for transforming said intermediate code into code suitable for use on said target platform.

14. The mechanism of claim 14 further comprising:
a means for preparing reports on said reverse engineered prepared source files.

15. The mechanism of claim 13 further comprising:
a means for creating transformation rules to assist with said transforming means; and
a means for inputting said transformation rules into said means for transforming said intermediate code.

16. A computer program product having a computer readable medium having computer program logic recorded thereon for transforming code suitable for use on a source platform to code suitable for use on a target platform, the computer program product comprising:
code for extracting relevant information from said code suitable for use on said source platform wherein said relevant information includes at least the logic, flow, user interface description, and data from said code suitable for use on said source platform;
code for converting said relevant information into a generic representation of elements that reflect said relevant information of said code suitable for use on said source platform; and
code for transforming said generic representation of elements into code suitable for use on said target platform.

17. The computer program product of claim 16 further comprising:
code for optimizing said code suitable for use on said source platform for extraction;

18. The computer program product of claim 16 further comprising:
code for generating reports based on said generic representation of elements.

19. The computer program product of claim 18 further comprising:
code for analyzing and processing said generic representation of information elements to assist said code for generating reports.

20. The computer program product of claim 16 further comprising:
code for generating an output file representing the code suitable for use on said target platform.

21. The computer program product of claim 16 wherein said code for transforming comprises:
code for inputting a set of transformation rules specific to said target platform; and
code for using said transformation rules to convert said generic representation of elements into said code suitable for use on said target platform.

22. The computer program product of claim 16 further comprising:
code for storing said generic representation of elements that reflect said relevant information of said code suitable for use on said source platform in XML format.

23. The computer program product of claim 22 further comprising:
code for generating an output file representing said generic representation of elements that reflect said relevant aspects of said code suitable for use on said source platform.

24. The computer program product of claim 17 wherein said code for optimizing comprises:
code for inputting system documentation of said code suitable for use on a source platform;
code for inputting said code suitable for use on said source platform; and
code for using said inputted documentation and said code suitable for use on said source platform to refine said code suitable for use on said source platform for extraction.

25. The computer program product of claim 24 wherein said code for optimizing further comprises:
code for performing customized extraction of information from said code suitable for use on said source platform.

26. A data processing system for transforming a computer program written for a source platform to a computer program written for a target platform comprising:
memory storing a transformation program operating to:
analyze a program operating on a source platform;
extract information from said analyzed source platform code, wherein said extracted information includes at least the logic, flow, user interface, and data of said source platform code;
define a generic data structure and format;
store said extracted information in said defined generic data structure and format; and
transform said extracted information stored in said defined generic data structure and format into code suitable for said target platform; and
a processor for executing said transformation program.

27. The data processing system of claim 26 wherein said defined structure and format is XML.

28. The data processing system of claim 26 wherein said transformation program operates to analyze a program operating on a source platform by:
defining a language recognition tool; and
using said defined language recognition tool to recognize elements of said program operating on said source platform.

29. The data processing system of claim 28 wherein said language recognition tool is based on an EBNF programming language grammar.

30. The data processing system of claim 29 wherein said transformation program operates to further analyze a program operating on a source platform by:
defining a custom analysis tool that is specific to said program operating on said source platform; and
using said defined custom analysis tool to pre-process said program operating on said source platform before said extracting of information.

31. The data processing system of claim 30 wherein said transformation program operates to further analyze a program operating on a source platform by:
defining a third party tool to be used for analyzing said source program operating on said source platform; and
using said defined third party tool to identify elements of said source program operating on said source platform that are relevant and not-relevant to said transforming of said extracted information.

32. The data processing system of claim 26 wherein said transformation program further operates to:
produce a report from said extracted information.

33. The data processing system of claim 32 wherein said transformation program further operates to:
analyze and perform an intermediate transformation of said extracted information to assist with said report producing.

34. The data processing system of claim 32 wherein said report comprises one or more of:
a user interface mock-up;
data definitions;
symbol counts;
application flow;
a generic XML report to assist in validating or verifying other complex manual migration of code from one platform to another platform; and
details of a status of migration of code from one platform to another platform for a user.

35. The data processing system of claim 26 wherein said transformation program operates to transform said extracted information by:
defining a set of transformation rules specific to said target platform; and
using said transformation rules in transforming said extracted information into code suitable for said target platform.
